(19) United States
(12) Patent Application Publication
(10) Pub. No.: US 2005/0091128 A1
(43) Pub. Date: Apr. 28, 2005

(54) System and method for querying inventory

(76) Inventors: Sheng-Chi Luo, Tu-Chen (TW); Wenbo Mao, Shenzhen (CN); Qiong Shuai Chen, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/920,752

(22) Filed: Aug. 17, 2004

(30) Foreign Application Priority Data
Oct. 24, 2003 (TW) 92129551

(51) Int. Cl. G06F 7/00

(52) U.S. Cl. 705/28

(57) ABSTRACT

A system used to query real-time inventory data for distributed storage locations includes a web server (11), an application server (12), a central database (13) and branch databases (16). Each branch database is located at a storage location, and stores inventory data for the storage location. The central database is used to store integrated inventory data. The web server includes a parameter receiving module (21) for receiving query parameters set by clients, a query sentence generating module (23) for generating query sentences according to the query parameters, and a statement generating module (25) for generating query result statements. The application server includes an inventory data searching module (33) for searching inventory data and update times of the inventory data from the central database, an update record searching module (35) for searching update records in the branch databases, and a data maintaining module (31) for updating the central database.

### BACKGROUND OF THE INVENTION

1. Field of the Invention

The present invention relates to inventory querying systems and methods, and particularly to an inventory querying system and method which can be used to query inventory data regarding distributed storage locations via electronic communication networks.

2. Background of the Invention

Efficient management of inventory is vital for businesses, especially for large-scale businesses such as multinational manufacturing corporations. Such businesses generally distribute their inventory in many different places, and require accurate assessments of their inventory at any place any time. For example, a business may need to know quantities of goods it currently has in storage so that it can timely replenish the goods and maintain appropriate buffer stocks of the goods.

With the development of information technology and the widespread use of computers, it is now feasible for most businesses to make accurate assessments of their inventory any time, wherever the goods may be located.

Taiwan Pat. No. 507,147 issued on Oct. 21, 2002 and entitled “Inventory System for a Plurality of Suppliers to Remotely Query” discloses methods and systems for suppliers to remotely query inventory via a network. The systems transmit inventory data between clients and suppliers by processing virtual inventory data and changing the format of the inventory data.

Taiwan Pat. No. 509,852 issued on Nov. 11, 2002 and entitled “System and Method for Querying Remote Inventory Database and Returning Query Result Real-timely by Using E-mails” discloses a system and method for querying remote inventory databases and obtaining query results in real time by using an E-mail system.

However, the abovementioned systems are limited to querying a single inventory database each time, and the inventory data retrieved from one inventory database are generally isolated from the inventory data retrieved from other inventory databases. In addition, it is inefficient to transmit all records among distributed inventory databases when making a query.

There is no known system or method which can effectively query inventory of distributed storage locations fast and timely and reduce communication traffic by using a central database to store integrated inventory data.

### SUMMARY OF THE INVENTION

Accordingly, a main objective of the present invention is to provide an inventory querying system and method which can be used for conveniently querying real time inventory data regarding distributed storage locations.

To accomplish the above objective, an inventory querying system (“the system”) in accordance with a preferred embodiment of the present invention is disclosed herein. The system includes a plurality of client computers, a web server, an application server, a central database, and a plurality of branch databases. The web server connects with the client computers and the application server via a network. The application server connects with the branch databases via the network, and interconnects with the central database via a connection. Each branch database is located in a respective storage location, and stores inventory data for the storage location. The central database is used to store integrated inventory data. The web server includes a parameter receiving module for receiving query parameters set by clients via the client computers, a query sentence generating module for generating query sentences according to the query parameters received, and a statement generating module for generating query result statements according to query results. The application server includes an inventory data searching module for searching inventory data required by clients and update times of the required inventory data in the central database and in the branch databases, an update record searching module for searching update records of the required inventory data in the branch databases, and a data maintaining module for updating inventory data stored in the central database in accordance with the update records.

Further, the present invention provides an inventory querying method comprising the steps of: (a) providing branch databases to store inventory data for storage locations respectively; (b) receiving query parameters and generating query sentences according to the parameters; (c) executing the query sentences and searching the central database for required inventory data and update times of the required inventory data; (d) determining whether the required inventory data exist in the central database; (e) searching the branch databases for update records of the required inventory data if the required inventory data exist in the central database, and updating the central database according to the update records; (f) searching the branch databases for the required inventory data if the inventory data and update times of the required inventory data do not exist in the central database, and storing the inventory data in the central database; and (g) outputting query results and generating query result statements according to the query results.

The inventory querying system and method of the present invention can query real time inventory data regarding distributed storage locations with reduced communication traffic.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware infrastructure of an inventory querying system in accordance with the preferred embodiment of the present invention;

FIG. 2 is a schematic diagram of main function units of a web server of the inventory querying system of FIG. 1;

FIG. 3 is a schematic diagram of main function units of an application server of the inventory querying system of FIG. 1;

FIG. 4 is a flowchart of a preferred method for querying inventory according to the present invention; and

FIG. 5 is a flowchart of a preferred method for implementing one of steps of FIG. 4, namely querying inventory data in a central database and branch databases according to query sentences.

### DETAILED DESCRIPTION OF THE PREFERRED EMBODIMENT

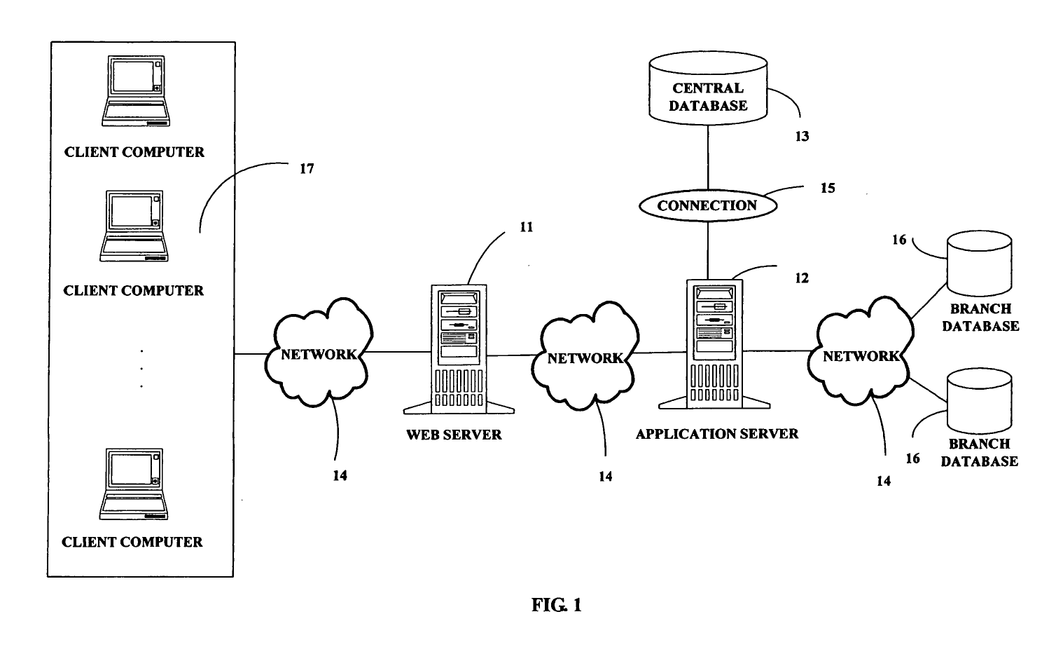

FIG. 1 is a schematic diagram of hardware infrastructure of an inventory querying system (hereinafter “the system”) in accordance with the preferred embodiment of the present invention. The system applies a 3-tier structure containing a plurality of client computers 17, a web server 11, an application server 12, a central database 13 and a plurality of branch databases 16. The client computers 17, the web server 11, the application server 12 and the branch databases 16 are interconnected through a network 14. The network 14 may be a local area network, a wide area network, or any other suitable type of electronic communications network. The application server 12 interconnects with the central database 13 through a connection 15. The connection 15 is a database connectivity such as an Open Database Connectivity (ODBC) or a Java Database Connectivity (JDBC). The application server 12 accesses the branch databases 16 via the network 14 to obtain inventory data for various storage locations of an enterprise and/or a partner of the enterprise. The central database 13 stores the inventory data for the storage locations, and also stores inventory data generated by integrating the inventory data for the storage locations.

The web server 11 is used for receiving query parameters from the client computers 17, generating query sentences, receiving query results from the application server 12, and generating query result statements. The application server 12 contains core and mutable enterprise logic (such as rules of planning, execution, and management) of the system, and is used for receiving input inventory data, processing the input inventory data, and outputting results of the processing. Each branch database 16 is located at a respective storage location, and stores inventory data for that storage location. The client computers 17 access the web server 11 through the network 14 by using website browsers such as Internet Explorer that available from Microsoft Corporation, or Netscape Navigator that available from Netscape Communication Corporation. The client computers 17 can thus transmit query parameters to the application server 12, and retrieve inventory data for the storage locations via the web server 11.

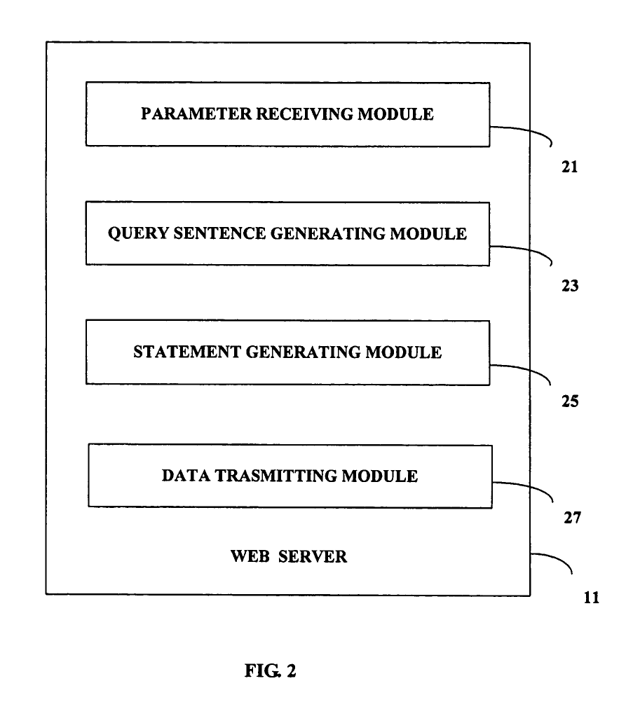

FIG. 2 is a schematic diagram of main function units of the web server 11. The web server 11 comprises a parameter receiving module 21, a query sentence generating module 23, a statement generating module 25, and a data transmitting module 27. The parameter receiving module 21 is used for receiving query parameters set by clients via the client computers 17, making simple logical judgments by determining whether formats and/or query scopes of the input query parameters accord with predefined formats and/or query scopes regarding the query parameters, transmitting messages such as “wrong input” to the client computers 17, and requesting re-inputting of query parameters if a format and/or a query scope of input query parameters do not accord with a predefined format and/or query scope. The query parameters comprise names of stored materials and of storage locations, and warehousing dates of the stored materials. The query sentence generating module 23 is used for generating query sentences according to the received query parameters. The statement generating module 25 is used for generating query result statements according to query results. The data transmitting module 27 is used for transmitting the query sentences to the application server 12, and transmitting the query result statements to the client computers 17.

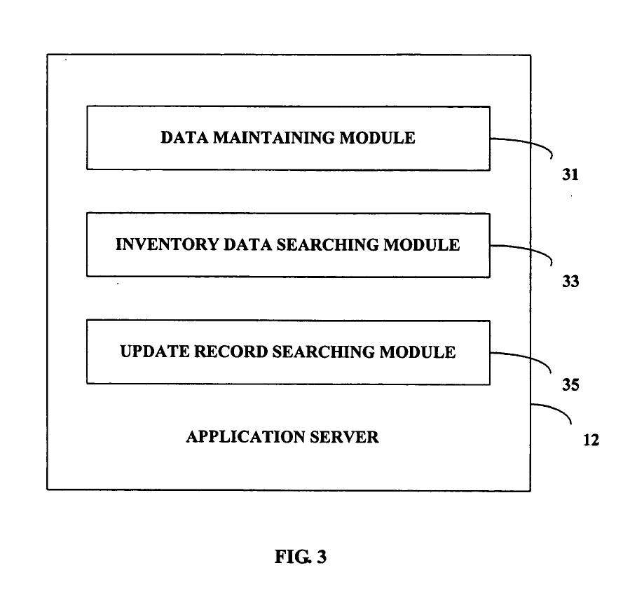

FIG. 3 is a schematic diagram of main function units of the application server 12. The application server 12 comprises a data maintaining module 31, an inventory data searching module 33, and an update record searching module 35. The data maintaining module 31 is used for maintaining inventory data stored in the central database 13. Such maintenance includes defining, establishing, modifying, adding, deleting and querying inventory data. The inventory data searching module 33 is used for searching required inventory data and update times of the required inventory data stored in the central database 13 and the branch databases 16. The update record searching module 35 is used for searching the branch databases 16 for update records of the required inventory data if the required inventory data exist in the central database 13. In the present invention, when inventory of any material stored in a storage location changes, corresponding inventory data of the material in a relevant branch database 16 are updated accordingly. An update record containing an update time of the material is generated, and replaces the original inventory data in the branch database 16. If the update time contained in the update record is later than the update time of the corresponding inventory data in the central database 13, the update record is regarded as being correct.

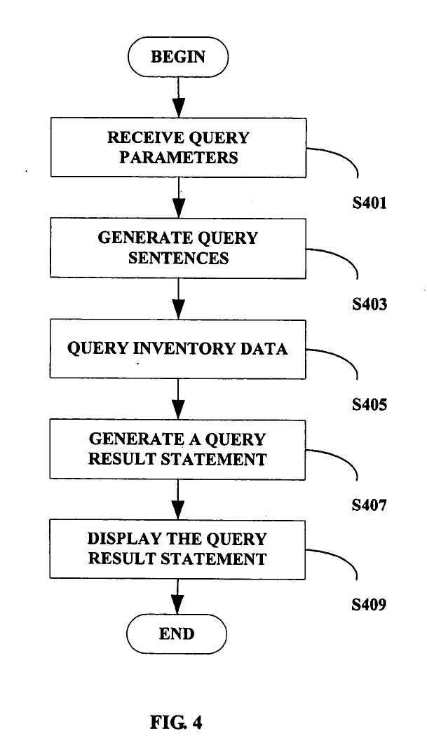

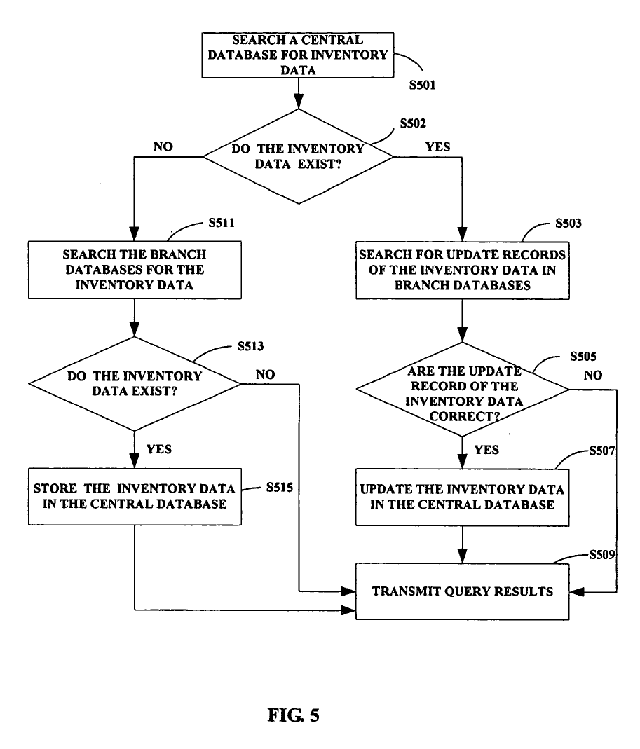

FIG. 4 is a flowchart of a preferred method for querying inventory according to the present invention. In step S401, the parameter receiving module 21 receives query parameters input by a client via one of the client computers 17, and makes a simple logical judgment by determining whether formats and/or query scopes of the input query parameters accord with predefined formats and/or query scopes regarding the query parameters. In step S403, the query sentence generating module 23 generates query sentences according to the received query parameters. The query sentences can be executed by the modules in the application server 12 in order to query required inventory data in the central database 13 and the branch databases 16. In step S405, the data transmitting module 27 transmits the query sentences to the application server 12. In step S407, the application server 12 queries corresponding inventory data in the central database 13 and the branch databases 16 according to the query sentences, and outputs query results (this is described in detail below in relation to FIG. 5). In step S409, the statement generating module 25 generates a query result statement according to the query results. The web server 11 stores various formats for a query result statement, from which the client can select a suitable format via the client computer 17. In step S411, the data transmitting module 27 transmits the query result statement to the corresponding client computer 17. The query result statement is displayed to the client through the client computer 17.

FIG. 5 is a flowchart of a preferred method for implementing step S407 of FIG. 4, namely querying inventory data in the central database 13 and the branch databases 16 according to the query sentences. In step S501, the inventory data searching module 33 searches in the central database 13 for the inventory data required by the client and update times of the inventory data. In step S502, the inventory data searching module 33 determines whether the required inventory data exist in the central database 13.

If the inventory data do not exist in the central database 13, the procedure goes to step S511 described below. If the inventory data exist in the central database 13, in step S503, the update record searching module 35 searches for update records of the required inventory data in the branch databases 16. In step S505, the update record searching module verifies whether the update records are correct by determining whether the update times contained in the update records are later than the update times of the corresponding inventory data stored in the central database 13. If any of the update records are not correct, the procedure goes directly to step S509 described below. If all the update records are correct, in step S507, the data maintaining module 31 updates the inventory data of the central database 13, and records the update times contained in the update records as the new update times of the required inventory data, whereupon the procedure goes to step S509. In step S509, the application server 12 transmits the query results to the web server 11.

In step S511, the inventory data searching module 33 searches the branch databases 16 for the required inventory data. In step S513, the inventory data searching module 33 determines whether the required inventory data exist in any of the branch databases 16. If the required inventory data do not exist in any of the branch databases 16, the procedure goes directly to step S509 described above. If the required inventory data exist in any of the branch databases 16, in step S515, the inventory data searching module 33 transmits the required inventory data to the data maintaining module 31, which stores the inventory data in the central database 13. Thereupon the procedure goes to step S509 described above.

Although the present invention has been specifically described on the basis of a preferred embodiment and a preferred method, the invention is not to be construed as being limited thereto. Various changes and modifications may be made to the embodiment and method without departing from the scope and spirit of the invention.

1. An inventory querying system for querying real-time inventory data regarding distributed storage locations, the inventory querying system comprising:
a plurality of branch databases for storing inventory data for distributed storage locations;
a central database for storing integrated inventory data;
a web server comprising:
a parameter receiving module for receiving query parameters from one or more client computers;
a query sentence generating module for generating query sentences according to said query parameters; and
a statement generating module for generating query result statements according to query results; and
an application server comprising:
an inventory data searching module for searching inventory data that clients require and update times of the required inventory data in the central database and the branch databases;
an update record searching module for searching update records in the branch databases according to the inventory data and update times of the inventory data; and
a data maintaining module for updating inventory data in the central database according to the update records.

2. The inventory querying system according to claim 1, wherein the web server further comprises an inventory data transmitting module for transmitting said query sentences to the application server, and for transmitting said query result statements to said client computers.

3. The inventory querying system according to claim 1, wherein the inventory data searching module also can be used for determining whether the required inventory data exist in the central database.

4. A computer based inventory querying method implemented by utilizing an inventory querying system, the inventory querying method comprising the steps of:
providing a plurality of branch databases for storing inventory data for distributed storage locations;
receiving query parameters input by one or more users via one or more client computers, and generating one or more query sentences according to the query parameters;
searching a central database for required inventory data and update times of the required inventory data;
determining whether the required inventory data exist in the central database;
searching the branch databases for update records of the required inventory data if the required inventory data exist in the central database, and updating inventory data stored in the central database according to the update records;
searching the branch databases for the required inventory data if the required inventory data do not exist in the central database; and
outputting one or more query results and generating one or more query result statements according to the query results.

5. The method according to claim 4, wherein the step of querying the branch databases for update records of the inventory data comprises verifying whether the update records in the branch databases are correct by determining whether the update times contained in the update records are later than the update times of the corresponding inventory data stored in the central database.

6. The method according to claim 4, wherein the step of querying the branch databases for the required inventory data further comprises storing the required inventory data in the central database.

7. A computer based inventory querying method implemented by utilizing an inventory querying system, the inventory querying method comprising the steps of:
providing a central database, and a plurality of branch databases for storing inventory data for distributed storage locations;
searching a central database for required inventory data and update times of the required inventory data;
determining whether the required inventory data exist in the central database;
searching the branch databases to see whether update records of the required inventory data exist if the required inventory data exist in the central database, and updating inventory data stored in the central database if said the update records exist;
searching the branch databases for the required inventory data if the required inventory data do not exist in the central database, and further adding the inventory data into the central database if the required data exist in at least one of the branch databases.
